(19) United States
(12) Patent Application Publication
(10) Pub. No.: US 2019/0371188 A1
(43) Pub. Date: Dec. 5, 2019

(54) STUDENT AID ASSEMBLY

(71) Applicant: Pamela Lee, Oro-Medonte (CA)

(72) Inventor: Pamela Lee, Oro-Medonte (CA)

(21) Appl. No.: 15/997,828

(22) Filed: Jun. 5, 2018

(51) Int. Cl. G09B 1/08; G09B 19/00; G09B 23/04; G09B 1/38

(52) U.S. Cl. CPC G09B 1/08; G09B 1/38; G09B 23/04; G09B 19/00

(57) ABSTRACT

A student aid assembly includes a magnetic panel that has a front side, a rear side and a peripheral edge. A plastic coating is non-removably attached to and covers the front side of the panel. The plastic coating comprises a dry erase board for displaying an erasable writing material. The plastic coating has a plurality of indicia positioned thereon and includes a blank space is bounded by a perimeter line. The blank space defines a name area to allow a person to write a name therein. The indicia includes a plurality of reference areas to assist a student with answering a school question.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

(1) Field of the Invention

(2) Description of Related Art including information disclosed under 37 CFR 1.97 and 1.98

The disclosure and prior art relates to name identification devices and more particularly pertains to a student aid device allowing a student to place their name upon the device and thereafter magnetically adhere the device to a desk.

### BRIEF SUMMARY OF THE INVENTION

An embodiment of the disclosure meets the needs presented above by generally comprising a magnetic panel that has a front side, a rear side and a peripheral edge. A plastic coating is non-removably attached to and covers the front side of the panel. The plastic coating comprises a dry erase board for displaying an erasable writing material. The plastic coating has a plurality of indicia positioned thereon and includes a blank space is bounded by a perimeter line. The blank space defines a name area to allow a person to write a name therein. The indicia includes a plurality of reference areas to assist a student with answering a school question.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a student aid assembly according to an embodiment of the disclosure.

FIG. 2 is a cross-sectional view of an embodiment of the disclosure taken along line 2-2 of FIG. 1.

### DETAILED DESCRIPTION OF THE INVENTION

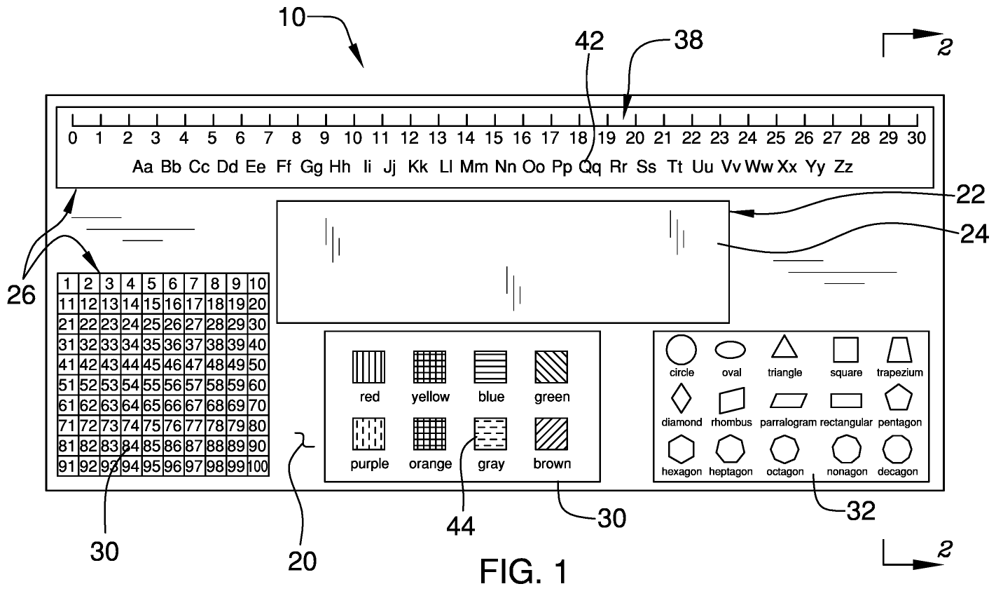

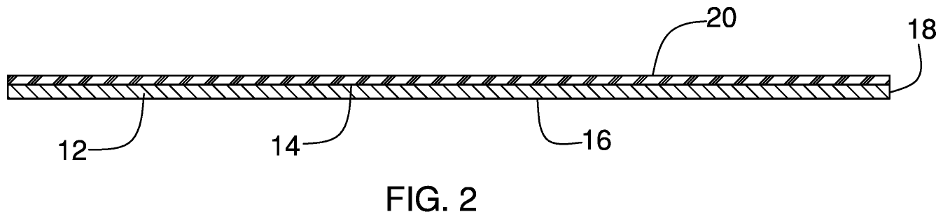

With reference now to the drawings, and in particular to FIGS. 1 through 2 thereof, a new name identification device embodying the principles and concepts of an embodiment of the disclosure and generally designated by the reference numeral 10 will be described.

As best illustrated in FIGS. 1 through 2, the student aid assembly 10 generally comprises a magnetic panel 12 that has a front side 14, a rear side 16 and a peripheral edge 18. The panel 12 may have a length generally between 6.0 inches and 18.0 inches and width between 3.0 inches and 12.0 inches. The magnetic panel 12 is magnetically active to allow it to adhere magnetically to a metallic object, such as a student's desk. The magnetic panel 12 may be flexible or rigid in construction. Alternatively, the magnetic panel 12 may comprise a plate that is coated with a magnetic material, such as a magnetic paint or to which a plurality of magnets is attached or imbedded within.

A plastic coating 20 is non-removably attached to and covers the front side 14 of the magnetic panel 12. The plastic coating 20 comprises a conventional dry erase board configured to display an erasable writing material.

The plastic coating 20 has a plurality of indicia positioned thereon. The indicia includes a blank space 24 that is bounded by a perimeter line 22. The blank space 28 defines a name area configured to allow a person, such as a student, to write a name therein thus identifying the desk as theirs.

The indicia includes a plurality of reference areas 26. Each of the reference areas 26 include a reference indicia. At least one of the reference areas is elongated and defines a ruler 38. The remaining reference areas including indicia that is selected from the group including number indicia 30, letter indicia 42, color indicia 44 and shape indicia 32.

In use, the reference areas are configured to assist a student with answering a school question and generally be useful for teaching younger children measurements, colors, shapes, numbers and the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A student name identification assembly comprising:
a magnetic panel having a front side, a rear side and a peripheral edge;
a plastic coating being non-removably attached to and covering said front side of said panel, said plastic coating comprising a dry erase board configured to display an erasable writing material;
said plastic coating having a plurality of indicia positioned thereon, said indicia including a blank space being bounded by a perimeter line, said blank space defining a name area configured to allow a person to write a name therein; and
said indicia including a plurality of reference areas, said reference areas being configured to assist a student with answering a school question.

2. The student name identification assembly according to claim 1, wherein at least one of said reference areas being elongated and defining a ruler.

3. The student name identification assembly according to claim 1, wherein said reference areas including indicia being selected from the group including number indicia, letter indicia, color indicia and shape indicia.

3. The student name identification assembly according to claim 2, wherein said reference areas include number indicia, letter indicia, color indicia and shape indicia.

4. A student name identification assembly comprising:
a magnetic panel having a front side, a rear side and a peripheral edge;
a plastic coating being non-removably attached to and covering said front side of said panel, said plastic coating comprising a dry erase board configured to display an erasable writing material;
said plastic coating having a plurality of indicia positioned thereon, said indicia including a blank space being bounded by a perimeter line, said blank space defining a name area configured to allow a person to write a name therein; and
said indicia including a plurality of reference areas, each of said reference areas including a reference indicia, at least one of said reference areas being elongated and defining a ruler, said reference areas including indicia being selected from the group including number indicia, letter indicia, color indicia and shape indicia, said reference areas being configured to assist a student with answering a school question.
